(19) United States
(12) Patent Application Publication
(10) Pub. No.: US 2004/0189253 A1
(43) Pub. Date: Sep. 30, 2004

(54) AC adapter power supply apparatus

(75) Inventors: Masao Tanabe, Kanagawa (JP); Mitsuru Kanno, Kanagawa (JP)

Correspondence Address: McDERMOTT, WILL & EMERY, 600 13th Street, N. W., Washington, DC, 20005-3096, US

(73) Assignee: YUTAKA ELECTRIC MFG. CO., LTD.

(21) Appl. No.: 10/812,948

(22) Filed: Mar. 31, 2004

(30) Foreign Application Priority Data
Mar. 31, 2003 (JP) 2003-95896

(51) Int. Cl. H02J 7/00

(52) U.S. Cl. 320/128

(57) ABSTRACT

An object of the present invention is to obtain a portable product capable of switching to a plurality of kinds of voltage, supporting any type of battery, and informing a user of an output voltage abnormality, service interruption and an end of discharge. It is an AC adapter power supply apparatus comprising a line for supplying a DC voltage of an AC-DC conversion circuit 11 directly to a DC output circuit 23, and a line for supplying the same from a battery 14, wherein an output side of a DC output detection circuit 17 connected to the AC-DC conversion circuit 11 is connected to an apparatus status output circuit 22 for outputting a status monitoring signal to the outside and to a battery switch circuit 15, and a changeover switch 19 for switching a set-up output voltage is connected to the AC-DC conversion circuit 11 and the DC-DC conversion circuit 16. And it is connected to a battery switch circuit 15 for controlling contact and separation of the battery 14, a switch 20 for turning on and off charging of the battery 14, and a cold start switch 21 for controlling connection of the battery 14.

### BACKGROUND OF THE INVENTION

1 Field of the Invention

The present invention relates to a portable AC adapter power supply apparatus for a portable small digital device, which has a backup to be usable in any country of a different voltage value of AC commercial power source and capable of operation without a stop on service interruption of AC input, instantaneous voltage reduction or voltage variation.

2 Description of the Related Art

Recently, small digital devices as load apparatuses such as a hub, a cordless phone, a digital board, a digital information appliance and a game console are carried and used not only in Japan but all over the world. For that reason, it has become necessary to take AC adapters along.

As for the load apparatuses connected to the AC adapters in the past, it was not considered problematic that instantaneous AC input voltage reduction, service interruption and voltage variation occurred. However, many of the recent load apparatuses assume a role of communication or a server so that they must be constantly in operation. For instance, there are built-in servers and communication converters, load apparatuses capable of monitoring and control by mans of communication and so on. And many of such load apparatuses are driven by a DC voltage.

Uninterruptible power supplies in the past are AC-output, and battery replacement thereof is difficult and batteries are sold in packs, which cannot be easily purchased.

The AC adapters in the past stop the DC voltage on the instantaneous voltage reduction and service interruption, and there is a possibility that they may stop the load apparatuses which must be constantly in operation.

There are proposed inventions (Japanese Patent Laid-Open No. 10-25829, Japanese Patent Document) as to the AC adapter to be used for this kind of load apparatus, wherein a secondary battery backs it up if a power cord comes off or a feeding function of the adapter is down due to the service interruption and so on.

According to this invention, it is an AC-power adapter used for a portable audio-video device such as a broadcast TV camera, capable of converting AC 100V to 240V into DC, connecting the secondary battery and backing it up if the feeding function of the adapter is down, charging the secondary battery in the case of a lithium-ion battery, and blocking the charging in the case of a nicad battery.

According to this past invention, however, the load is the AC-power adapter used for the broadcast TV camera which is the audio-video device requiring high power. And the AC-power adapter is normally used by being connected to an AC outlet, and is used only for a temporary backup in the case where a power cable has come off the AC outlet, and has problems that a capacity of the AC-power adapter itself is too large to be portable, it has only one preset output voltage value because of only one kind of load, and an example of the lithium-ion battery or the nickel-cadmium battery is described but no mention is made as to use of other batteries available to consumers.

The present invention is not only intended to solve these problems, but its objects are to obtain the one capable of switching to a plurality of kinds of voltage according to the voltage of the load, obtain the one capable of supporting any type of battery whether rechargeable or not, obtain the one capable of informing a user of an output voltage abnormality, service interruption, an end of discharge and so on, and obtain the one portable and miniaturized as much as possible.

### SUMMARY OF THE INVENTION

The present invention is an AC adapter power supply apparatus comprising a line for supplying a DC voltage converted by an AC-DC conversion circuit 11 to a DC output circuit 23, a battery switch circuit 15 for supplying the DC voltage converted by the AC-DC conversion circuit 11 to a battery 14 via a charging circuit 13 and controlling contact and separation of the battery 14 and a DC-DC conversion circuit 16 from the battery 14, and a line for supplying to the output circuit 23 via the DC-DC conversion circuit 16 for increasing and decreasing the voltage, wherein a DC output detection circuit 17 is connected to an output side of the AC-DC conversion circuit 11, and an output side of the DC output detection circuit 17 is connected to an apparatus status output circuit 22 for outputting a status monitoring signal to the outside and to the battery switch circuit 15, and then an output voltage changeover switch 19 for switching a set-up output voltage is connected to the AC-DC conversion circuit 11 and the DC-DC conversion circuit 16.

And the battery 14 is connected to a battery voltage detection circuit 18 for detecting the voltage of the battery 14, the output side of the battery voltage detection circuit 18 is connected to the apparatus status output circuit 22 for outputting the status monitoring signal to the outside and to the battery switch circuit 15 for controlling the contact and separation of the battery 14 and the DC-DC conversion circuit 16.

The charging circuit 13 is connected to a charging on-off switch 20 for outputting a signal which connects the AC-DC conversion circuit 11 to the battery 14 when the battery 14 is the secondary battery and separates the AC-DC conversion circuit 11 from the battery 14 when the battery 14 is a primary battery.

The battery switch circuit 15 is connected to a cold start switch 21 for connecting the battery 14 to the DC-DC conversion circuit 16 for the sake of connecting the battery 14 to the DC output circuit 23 when there is no AC input and interrupting the battery 14 from the DC output circuit 23 when the AC input is normally supplied from the AC-DC conversion circuit 11 to the DC output circuit 23.

In such a configuration, the DC voltage of the AC-DC conversion circuit 11 is sent to the DC output circuit 23 to supply a predetermined DC voltage from the DC output circuit 23 to a load 24 on the one hand, and the DC voltage is sent to the charging circuit 13 on the other hand. In the case where the battery 14 is rechargeable, an on signal is outputted from the charging on-off switch 20 to charge the battery 14. In the case where the battery 14 is not rechargeable, an off signal is outputted from the charging on-off switch 20 to prohibit charging of the battery 14.

The DC output detection circuit 17 constantly detects a DC input voltage and sends it to the apparatus status output circuit 22 to monitor whether it is normal or abnormal and output it to an external circuit.

In the case where it is abnormal, the DC output detection circuit 17 sends a signal to the battery switch circuit 15 to connect the battery 14 to the DC-DC conversion circuit 16, and the DC voltage set by the output voltage changeover switch 19 is supplied to the DC output circuit 23.

A voltage value of the battery 14 is constantly detected by the battery voltage detection circuit 18. If it becomes an over-discharge voltage, the battery voltage detection circuit 18 sends the signal to the apparatus status output circuit 22, and sends a communication signal to the external circuit for monitoring a status and also sends the signal to the battery switch circuit 15 so as to separate the battery 14 from the DC-DC conversion circuit 16.

If an AC power supply 10 recovers, the battery 14 restarts charging via the charging circuit 13. And if it completes the charging, that charging voltage is detected by the battery voltage detection circuit 18 so as to separate the charging circuit 13 and stop the charging. It sends the signal representing the recovery to the apparatus status output circuit 22.

Next, when supplying the DC voltage to the DC output circuit 23 where there is no AC power supply 10 or during service interruption of the AC power supply 10, the signal for turning on the cold start switch 21 is sent to the battery switch circuit 15 so as to supply it from the battery 14.

### BRIEF DESCRIPTION OF THE DRAWINGS

FIG. 1 is an electric circuit diagram showing an embodiment of an AC adapter power supply apparatus according to the present invention;

FIG. 2 is an electric circuit diagram for explaining an overview operation of the AC adapter power supply apparatus according to the present invention; and

FIG. 3 is a perspective view showing an embodiment of an appearance of the AC adapter power supply apparatus according to the present invention.

### DETAILED DESCRIPTION OF THE PREFERRED EMBODIMENTS

Hereafter, an embodiment of the present invention will be described based on the drawings.

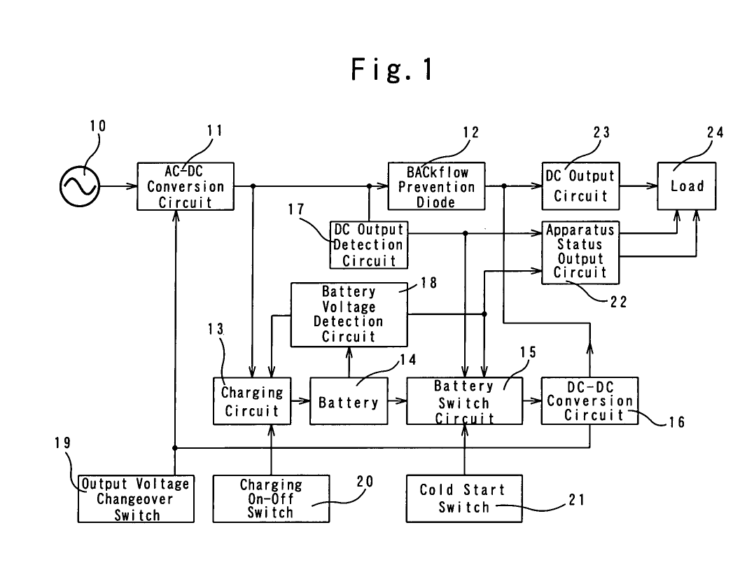

In FIG. 1, reference numeral 10 denotes an AC power supply. An AC-DC conversion circuit 11 connected to this AC power supply 10 is comprised of an AC-DC converter, and contains a circuit switchable according to an applied voltage of a load 24 under an instruction from an output voltage changeover switch 19.

The AC-DC conversion circuit 11 is connected to the load 24 via a backflow prevention diode 12 and a DC output circuit 23.

The AC-DC conversion circuit 11 is also connected to a charging circuit 13 and a DC output detection circuit 17. And the charging circuit 13 is connected from a battery 14 to a battery switch circuit 15 for controlling contact and separation of the battery 14 and a DC-DC conversion circuit 16 and further to the DC output circuit 23 via the DC-DC conversion circuit 16 for increasing and decreasing the voltage. The DC output detection circuit 17 is connected to the battery switch circuit 15 and an apparatus status output circuit 22 which is connected to the load 24.

The battery 14 is connected to a battery voltage detection circuit 18 for detecting a voltage of the battery 14. The battery voltage detection circuit 18 sends a charging completion signal to the charging circuit 13, and also sends a signal to the battery switch circuit 15 and the apparatus status output circuit 22 if the battery 14 reaches an over-discharge voltage status.

The output voltage changeover switch 19 is connected to the DC-DC conversion circuit 16 in addition to the AC-DC conversion circuit 11, and sends an output voltage switching signal to control switching of the output voltage corresponding to the load 24.

The charging circuit 13 is connected to a charging on-off switch 20 for outputting an on signal when the battery 14 is a rechargeable secondary battery and outputting an off signal when it is an unrechargeable primary battery.

The battery switch circuit 15 is connected to a cold start switch 21 for outputting the on signal for connecting the battery 14 to the DC-DC conversion circuit 16 when using it at a place where there is no AC power supply 10 or on service interruption of the AC power supply 10.

FIG. 3 is a perspective view showing an embodiment of an AC adapter power supply apparatus having incorporated the above circuit configuration.

In FIG. 3, an AC adapter housing 25 is miniaturized so that it becomes a hand-held size and easily portable. A battery loading concave portion 27 on the front of the AC adapter housing 25 can have the battery 14 which is a nickel hydride battery available to consumers for instance detachably loaded thereon. The battery 14 may of course be a battery pack or an unrechargeable battery, and a type thereof is not limited.

The AC-DC conversion circuit 11 may be constituted either to be separate from the AC adapter housing 25 or to be contained therein. The AC adapter housing 25 has the output voltage changeover switch 19, charging on-off switch 20 and cold start switch 21 formed therein, and has a charging indication lamp 26 for indicating charging provided therein. Reference numeral 28 denotes a DC output terminal to be connected to the load 24.

Actions of the above configuration will be described.

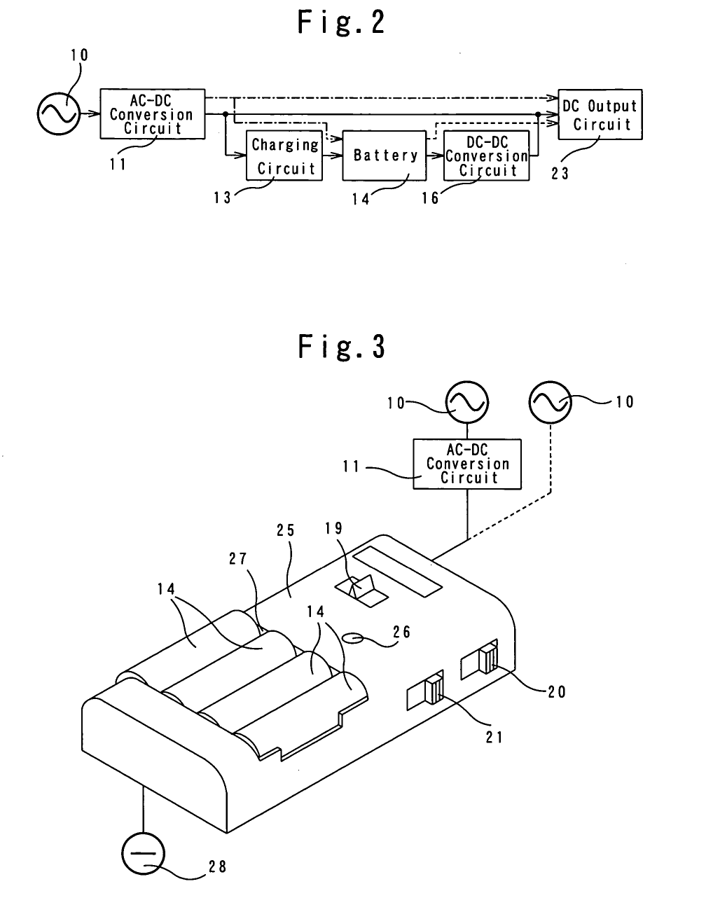

If an AC input voltage of AC 90V to 240V is normally inputted from the AC power supply 10 to the AC-DC conversion circuit 11, as indicated by dashed lines in FIG. 2, a DC voltage of the AC-DC conversion circuit 11 is sent to the DC output circuit 23 on the one hand and a predetermined DC voltage is supplied from the DC output circuit 23 to the load 24, and the DC voltage is sent to the charging circuit 13 to charge the battery 14 on the other hand.

As indicated by dotted lines in FIG. 2, in a status in which the AC power supply 10 is abnormal, it is increased or decreased to the predetermined voltage from the battery 14 via the DC-DC conversion circuit 16 so that the predetermined DC voltage is supplied from the DC output circuit 23 to the load 24.

To describe it further in detail, the DC voltage converted by the AC-DC conversion circuit 11 when the AC power supply 10 is normal is outputted after being converted to the DC voltage corresponding to the load 24 specified by the output voltage changeover switch 19.

The DC voltage of the AC-DC conversion circuit 11 is sent to the DC output circuit 23 via a backflow prevention diode 12 to have the predetermined DC voltage supplied from the DC output circuit 23 to the load 24 on the one hand, and the DC voltage is sent to the charging circuit 13 on the other hand. Here, in the case where the battery 14 is the secondary battery which is rechargeable, the on signal is outputted from the charging on-off switch 20 to charge the battery 14. In the case where the battery 14 is the primary battery which is not rechargeable, the off signal is outputted from the charging on-off switch 20 to prohibit charging of the battery 14.

The DC output detection circuit 17 constantly detects the output voltage of the AC-DC conversion circuit 11 and sends its voltage value to the apparatus status output circuit 22 to monitor whether it is normal or abnormal and output it to the load 24 and an external circuit.

Here, if service interruption, instantaneous voltage reduction or voltage variation occurs to the AC power supply 10, the output voltage of the AC-DC conversion circuit 11 also varies. Therefore, this variation is detected by the DC output detection circuit 17, and the signal is sent from the DC output detection circuit 17 to the apparatus status output circuit 22 so as to send a communication signal for monitoring the status from the apparatus status output circuit 22 to the load 24 and the external circuit.

At the same time, the signal is also sent from the DC output detection circuit 17 to the battery switch circuit 15 so as to connect the battery 14 to the DC-DC conversion circuit 16. Then, the DC-DC conversion circuit 16 is activated to increase and decrease the voltage, and the DC voltage set by the output voltage changeover switch 19 based on the increased or decreased voltage is supplied to the DC output circuit 23 and is further applied to the load 24 so that the load 24 is backed up to continue a normal operating status.

The voltage value of the battery 14 is constantly detected by the battery voltage detection circuit 18. If a remaining charging amount of the battery 14 becomes small and the voltage value becomes close to a discharge final voltage, the battery voltage detection circuit 18 sends the signal to the apparatus status output circuit 22, and the apparatus status output circuit 22 sends the communication signal for monitoring the status to the load 24 and external circuit. In the case where it is reduced to the discharge final voltage from this status, the signal is sent to the battery switch circuit 15 so as to separate the battery 14 from the DC-DC conversion circuit 16 and stop the DC-DC conversion circuit 16.

If the AC power supply 10 recovers and the output voltage of the AC-DC conversion circuit 11 returns to normal before the remaining charging amount of the battery 14 becomes an over-discharge voltage, the voltage is detected by the DC output detection circuit 17. And the signal representing recovery is sent from the DC output detection circuit 17 to the apparatus status output circuit 22 so as to send the communication signal for monitoring the status from the apparatus status output circuit 22 to the load 24 and the external circuit. And the signal is sent to the battery switch circuit 15 so as to separate the battery 14 from the DC-DC conversion circuit 16 and stop the DC-DC conversion circuit 16. If the output voltage of the AC-DC conversion circuit 11 returns to normal due to the recovery of the AC power supply 10, the battery 14 restarts the charging via the charging circuit 13. On completion of the charging, the charging voltage thereof is detected by the battery voltage detection circuit 18, and the charging is stopped by separating the charging circuit 13. The signal representing the recovery is sent from the battery voltage detection circuit 18 to the apparatus status output circuit 22 so as to send the communication signal for monitoring the status from the apparatus status output circuit 22 to the load 24 and the external circuit.

Next, in the case of supplying the DC voltage to the DC output circuit 23 at the place where there is no AC power supply 10 or on service interruption of the AC power supply 10, the signal for turning on the cold start switch 21 is sent to the battery switch circuit 15 so that the battery switch circuit 15 connects the battery 14 to the DC-DC conversion circuit 16. Thus, the DC-DC conversion circuit 16 is activated and the DC voltage set by the output voltage changeover switch 19 is supplied to the DC output circuit 23 so as to bring the load 24 into operation. And the signal representing the recovery is sent from the battery voltage detection circuit 18 to the apparatus status output circuit 22 so as to send the communication signal for monitoring the status from the apparatus status output circuit 22 to the load 24 and the external circuit.

In this case, as previously described, if the voltage value of the battery 14 becomes the over-discharge voltage, the battery voltage detection circuit 18 sends the signal to the apparatus status output circuit 22, and the apparatus status output circuit 22 sends the communication signal for monitoring the status to the load 24 and the external circuit and also sends the signal to the battery switch circuit 15 so as to separate the battery 14 from the DC-DC conversion circuit 16 and stop the DC-DC conversion circuit 16.

The invention according to claim 1 is the AC adapter power supply apparatus comprising a line for supplying the DC voltage converted by the AC-DC conversion circuit 11 to the DC output circuit 23, the battery switch circuit 15 for supplying the DC voltage converted by the AC-DC conversion circuit 11 to the battery 14 via the charging circuit 13 and controlling the contact and separation of the battery 14 and the DC-DC conversion circuit 16 from the battery 14, and the line for supplying to the DC output circuit 23 via the DC-DC conversion circuit 16 for increasing and decreasing the voltage, wherein the DC output detection circuit 17 is connected to an output side of the AC-DC conversion circuit 11, and the output side of the DC output detection circuit 17 is connected to the apparatus status output circuit 22 for outputting the status monitoring signal to the outside and to the battery switch circuit 15, and then the output voltage changeover switch 19 for switching a set-up output voltage is connected to the AC-DC conversion circuit 11 and the DC-DC conversion circuit 16. Therefore, it is possible to obtain a portable and small-size AC-power adapter. It is also possible to switch among a plurality of kinds of voltages according to the voltage of the load, and further to inform a user of an output voltage abnormality, service interruption and so on

As for the invention according to claim 2, the battery 14 is connected to the battery voltage detection circuit 18 for detecting the voltage of the battery 14, and the output side of the battery voltage detection circuit 18 is connected to the apparatus status output circuit 22 for outputting the status monitoring signal to the outside and to the battery switch circuit 15 for controlling the contact and separation of the battery 14 and the DC-DC conversion circuit 16. Therefore, it is possible to inform the user of the over-discharge voltage and a discharge final voltage.

As for the invention according to claim 3, the charging circuit 13 is connected to the charging on-off switch 20 for outputting the signal which connects the AC-DC conversion circuit 11 to the battery 14 when the battery 14 is the secondary battery and separates the AC-DC conversion circuit 11 from the battery 14 when the battery 14 is the primary battery. Therefore, it is possible to support any type of battery including a rechargeable one and an unrechargeable one.

As for the invention according to claim 4, the battery switch circuit 15 is connected to the cold start switch 21 for connecting the battery 14 to the DC-DC conversion circuit 16 for the sake of connecting the battery 14 to the DC output circuit 23 when there is no AC input and interrupting the battery 14 from the DC output circuit 23 when the AC input is normally supplied from the AC-DC conversion circuit 11 to the DC output circuit 23. Therefore, it is possible to always carry it and use it in any country of a different voltage of commercial power source, at a place having no AC outlet and as a battery charger in addition.

What is claimed is:

1. An AC adapter power supply apparatus comprising a line for supplying a DC voltage converted by an AC-DC conversion circuit 11 to a DC output circuit 23, a battery switch circuit 15 for supplying the DC voltage converted by the AC-DC conversion circuit 11 to a battery 14 via a charging circuit 13 and controlling contact and separation of the battery 14 and a DC-DC conversion circuit 16 from the battery 14, and a line for supplying to the DC output circuit 23 via the DC-DC conversion circuit 16 for increasing and decreasing the voltage, wherein a DC output detection circuit 17 is connected to an output side of the AC-DC conversion circuit 11, and the output side of the DC output detection circuit 17 is connected to an apparatus status output circuit 22 for outputting a status monitoring signal to the outside and to the battery switch circuit 15, and then an output voltage changeover switch 19 for switching a set-up output voltage is connected to the AC-DC conversion circuit 11 and the DC-DC conversion circuit 16.

2. The AC adapter power supply apparatus according to claim 1, wherein the battery 14 is connected to a battery voltage detection circuit 18 for detecting a voltage of the battery 14, and the output side of the battery voltage detection circuit 18 is connected to the apparatus status output circuit 22 for outputting the status monitoring signal to the outside and to the battery switch circuit 15 for controlling the contact and separation of the battery 14 and the DC-DC conversion circuit 16.

3. The AC adapter power supply apparatus according to claim 1, wherein the charging circuit 13 is connected to a charging on-off switch 20 for outputting a signal which connects the AC-DC conversion circuit 11 to the battery 14 when the battery 14 is a secondary battery and separates the AC-DC conversion circuit 11 from the battery 14 when the battery 14 is a primary battery.

4. The AC adapter power supply apparatus according to claim 1, wherein the battery switch circuit 15 is connected to a cold start switch 21 for connecting the battery 14 to the DC-DC conversion circuit 16 for the sake of connecting the battery 14 to the DC output circuit 23 when there is no AC input and interrupting the battery 14 from the DC output circuit 23 when the AC input is normally supplied from the AC-DC conversion circuit 11 to the DC output circuit 23.
